(19) United States
(12) Patent Application Publication
(10) Pub. No.: US 2016/0147652 A1
(43) Pub. Date: May 26, 2016

(54) DATA STORAGE SYSTEM AND CONTROL METHOD THEREOF

(71) Applicant: CHUO UNIVERSITY, Tokyo (JP)

(72) Inventors: Kosuke MIYAJI, Kawasaki-shi (JP); Chao SUN, San Jose, CA (US); Ken TAKEUCHI, Yokohama-shi (JP)

(73) Assignees: CHUO UNIVERSITY, Hachioji-shi, Tokyo (JP); CHUO UNIVERSITY, Hachioji-shi, Tokyo (JP)

(21) Appl. No.: 14/891,425

(22) PCT Filed: May 8, 2014
(86) PCT No.: PCT/JP2014/002450

§ 371 Date: Nov. 16, 2015

(30) Foreign Application Priority Data
May 17, 2013 (JP) 2013-105094

(51) Int. Cl. G06F 12/02

(52) U.S. Cl. CPC G06F 12/0253; G06F 12/0246; G06F 2212/1044; G06F 2212/2022; G06F 2212/7205

(57) ABSTRACT

Degradation in processing capability due to copying during garbage collection is reduced. A data storage system includes a memory unit provided with a memory, into which data are written in units of pages, and a memory controller that controls writing of data to the memory; and a controller that indicates, to the memory controller, a logical page address to which data are to be written. The memory controller determines a target block that is a block to be erased when garbage collection is next performed and provides the controller with information on a logical page address corresponding to a physical page address of a valid page in the target block. The controller instructs the memory controller to write data to the logical page address received from the memory controller.

### CROSS-REFERENCE TO RELATED APPLICATION

This application claims priority to and the benefit of Japanese Patent Application No. 2013-105094 filed May 17, 2013, the entire contents of which are incorporated herein by reference.

### TECHNICAL FIELD

This disclosure relates to a data storage system and a control method thereof. In particular, this disclosure relates to a data storage system that performs garbage collection and to a control method thereof.

### BACKGROUND

Recently, the use of Solid State Drives (SSDs), which are high-speed and have low power consumption, in data storage systems used in applications that handle big data, such as a Structured Query Language (SQL) database, has been examined.

As an example of the structure of an SSD, a hybrid SSD that combines high-speed ReRAM with high-density NAND flash memory has been proposed (for example, see H. Fujii et al., “x11 performance increase, x6.9 endurance enhancement, 93% energy reduction of 3D TSV-integrated hybrid ReRAM/MLC NAND SSDs by data fragmentation suppression”, Symp. VLSI Circuits 2012, pp. 134-135 (NPL 1)). For reasons such as cost reduction, however, SSDs that use only NAND flash memory are also being examined.

In databases such as SQL, row data are used as a unit in the database. An SSD executes processing (queries) such as insert, erase, and update in units of row data. The size of row data is normally approximately several hundred bytes.

FIGS. 8A and 8B illustrate an example of handling data in the logical address space and the physical address space. FIG. 8A illustrates the logical address space, and FIG. 8B illustrates the physical address space. As illustrated in the physical address space, in NAND flash memory, a page is formed by a group of memory cells having a common gate, and a block is formed by a plurality of pages. In the example illustrated in FIGS. 8A and 8B, one page is 16 kilobytes. One block includes 256 pages.

In NAND flash memory, the unit of writing is a page. As illustrated in FIGS. 8A and 8B, the data size of one page is approximately 16 kilobytes. which is lamer than the data size of row data, i.e. approximately several hundred bytes. In NAND flash memory, the unit of erasure is a block. In the example in FIGS. 8A and 8B, Physical Page Addresses (PPAs) 0 to 255 are allocated in block 0, and PPAs 256 to 511 are allocated in block 1.

As described above, since the unit of writing in NAND flash memory is a page, an instruction to write in NAND flash memory is issued with a Logical Page Address (LPA) indicated in the logical address space in FIG. 8A. A logical page address has a data size equivalent to that of a physical page address. A Logical Address (LA) is an address corresponding to the data size of row data.

When the controller of NAND flash memory is instructed to write to a certain logical page address, the controller converts the logical page address to a physical page address and writes the data. The correspondence between logical page addresses and physical page addresses is not fixed, but rather changes in accordance with the condition of use of the NAND flash memory. The controller of the NAND flash memory stores the correspondence between logical page addresses and physical page addresses.

FIG. 9 illustrates the process to update row data in NAND flash memory. Block 201 illustrated to the left includes row data to be updated, whereas block 202 to the right includes free pages into which data can be written.

In the example illustrated in FIG. 9, the fifth row data from the left in the third page from the top of block 201 is updated. In this case, since data cannot be written by row, the NAND flash memory reads the page that includes row data to be updated (S101). Next, in the read page data, the NAND flash memory replaces the fifth data from the left with the updated data (S102). The NAND flash memory then writes the page of updated data in block 202 (S103). Subsequently, the NAND flash memory sets the original page in block 201 (the third page from the top) to be an invalid page (S104).

In this way, in an SSD that uses NAND flash memory, since the unit of writing data is a page, an invalid page occurs each time data are updated. The same is also true when data are not being updated but rather inserted into a free area of a page. Accordingly, in NAND flash memory, upon each insertion or update, the number of invalid pages increases, and the amount of free space decreases. Therefore, when the amount of free space decreases and falls below a predetermined threshold, an SSD performs garbage collection to generate free space.

FIG. 10 is a flowchart illustrating an example of the garbage collection process.

When the free space in the NAND flash memory becomes smaller than a predetermined threshold, the SSD selects a block to be erased (“target block”) and reads the data in all of the valid pages in the target block (step S201). Next, the SSD writes the data of the read valid pages into a block for writing that has free pages (step S202). The SSD then erases the data in the target block (step S203).

In this way, when the free space in the NAND flash memory decreases, the SSD can increase the amount of free space by performing garbage collection and erasing the data in the target block.

### CITATION LIST

### Non-Patent Literature

NPL 1: If, Fujii et al., “x11 performance increase, x6.9 endurance enhancement, 93% energy reduction of 3D TSV-integrated hybrid ReRAM/MLC NAND SSDs by data fragmentation suppression”. Symp. VLSI Circuits 2012, pp. 134-135

### SUMMARY

### Technical Problem

Since the unit of erasure in NAND flash memory is a block, however, in order to generate a free block, at the time of garbage collection it is necessary to copy valid pages in the target block selected by wear-leveling or the like into free pages of another block, set all of the pages in the target block to be invalid pages, and then erase the entire block.

In this case, if the number of valid pages in the target block is large, a long time is required to copy all of the valid pages. For example, if it takes approximately 1.7 ms to copy one page, and the number of valid pages is approximately 100, then a long time of 100 ms or greater is required for the copy.

In such a data storage system, it thus takes time to copy valid pages during garbage collection, leading to the problem of degradation in processing capability. Furthermore, if the free space in the memory decreases, then garbage collection occurs frequently, thereby the problem of the degradation in processing capability becoming more significant as the amount of free space in the memory decreases.

Therefore, it would be helpful to provide a data storage system, and control method thereof, that can reduce the degradation in processing capability due to copying at the time of garbage collection.

### Solution to Problem

In order to solve the above problem, the disclosed data storage system includes a memory unit comprising a memory, into which data are written in units of pages, and a memory controller configured to control writing of data the memory; and a controller configured to indicate, to the memory controller, a logical page address to which data are to be written, such that the memory controller determines a target block that is a block to be erased when garbage collection is next performed, and provides the controller with information on a logical page address corresponding to a physical page address of a valid page in the target block, and the controller instructs the memory controller to write data to the logical page address received from the memory controller.

In the disclosed data storage system, the controller may instruct the memory controller to write the data by distributing the data between each logical page address received from the memory controller.

In the disclosed data storage system, when updating data stored in the memory, the controller may instruct the memory controller to erase non-updated data and to write newly updated data to the logical page address received from the memory controller.

In the disclosed data storage system, the memory controller may start garbage collection upon free space in the memory falling below a predetermined threshold.

In order to solve the above problem, the disclosed method of controlling a data storage system is a method of controlling a data storage system that includes a memory into which data are written in units of pages, the method including: determining a target block that is a block to be erased when garbage collection is next performed; converting a physical page address of a valid page in the target block into a corresponding logical page address; and writing data to the logical page address yielded by conversion.

### Advantageous Effect

The disclosed data storage system, and control method thereof, can reduce the degradation in processing capability due to copying at the time of garbage collection.

### BRIEF DESCRIPTION OF THE DRAWINGS

In the accompanying drawings:

FIG. 1 schematically illustrates the structure of a data storage system according to one of the disclosed embodiments;

FIGS. 2A and 2B illustrate an example of memory in a data storage system according to one of the disclosed embodiments;

FIGS. 3A and 3B illustrate an example of inserting row data in a data storage system according to one of the disclosed embodiments;

FIGS. 4A and 4B illustrate an example of updating row data in a data storage system according to one of the disclosed embodiments;

FIGS. 5A, 5B, and 5C illustrate the results of simulating the dependency of characteristics on the free space in the memory in a data storage system according to one of the disclosed embodiments;

FIGS. 6A and 6B illustrate the results of simulating the dependency of characteristics on the block size in the memory in a data storage system according to one of the disclosed embodiments;

FIG. 7 illustrates the results of simulating the time dependency of processing capability in a data storage system according to one of the disclosed embodiments;

FIGS. 8A and 8B illustrate an example of handling data in the logical address space and the physical address space;

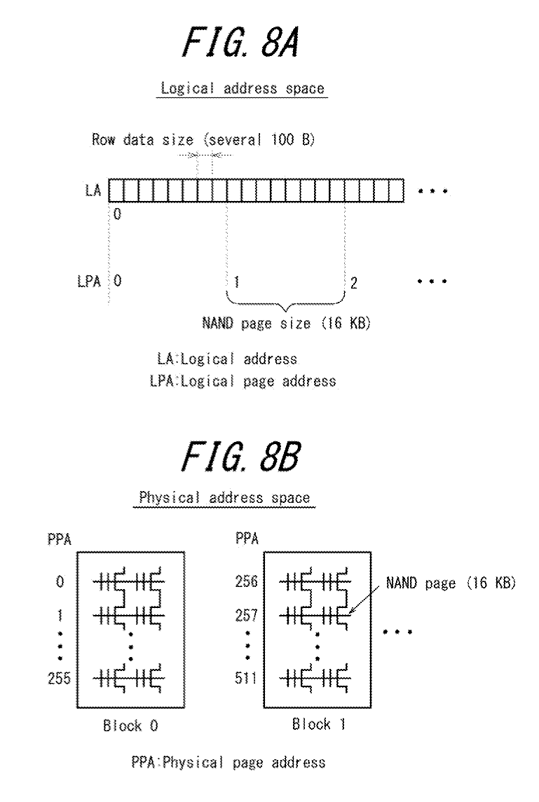

FIG. 9 illustrates an example of the process to update row data in NAND flash memory; and

FIG. 10 is a flowchart illustrating an example of the garbage collection process.

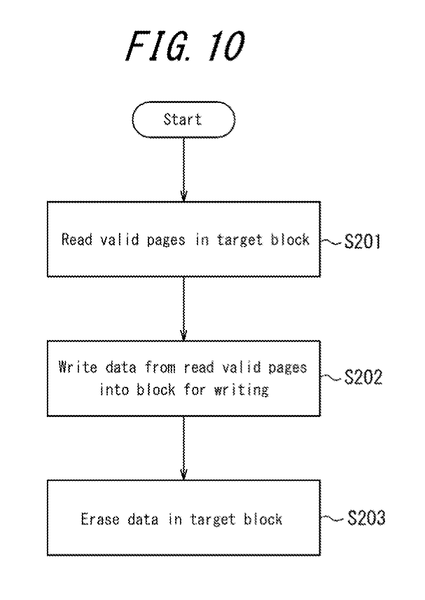

### DETAILED DESCRIPTION

The following describes the disclosed embodiments with reference to the drawings.

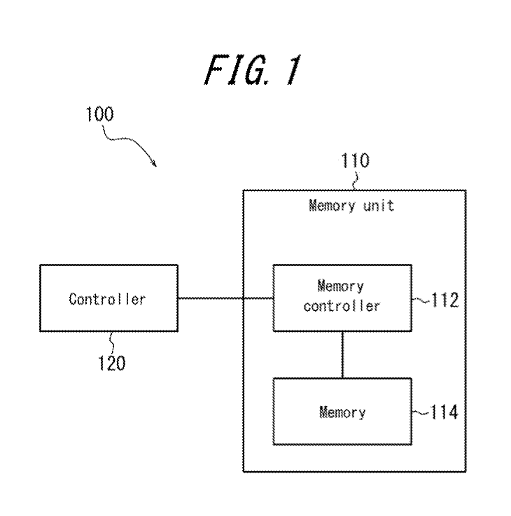

FIG. 1 schematically illustrates the structure of a data storage system according to one of the disclosed embodiments. A data storage system 100 includes a memory unit 110 and a controller 120. The memory unit 110 may, for example, be an SSD. The controller 120 is, for example, typically referred to as a data storage engine and may be implemented as software that is executed by a Central Processing Unit (CPU).

The memory unit 110 includes a memory controller 112 and a memory 114 formed by NAND flash memory.

For example from the perspective of wear-leveling, the memory controller 112 determines a target block in the memory 114. The target block is a block that is to be erased upon the next garbage collection.

The memory controller 112 converts the physical page address of a valid pane in the target block into a logical pane address and provides information on the logical page address to the controller 120.

The memory controller 112 monitors the free space in the memory 114. When the free space in the memory 114 falls below a predetermined threshold, the memory controller 112 starts garbage collection on the target block that was determined in advance.

Upon receiving an instruction from the controller 120 to execute an insert, erase, or update process on a certain logical page address, the memory controller 112 converts the logical page address to a physical page address and then executes the insert, erase, or update process on the physical page address in the memory 114.

When writing to the memory 114, the memory controller 112 cannot overwrite the same physical page address without first performing an erase. Therefore, as a page, the memory controller 112 reads the data at the logical page address that is to be written to, adds the row data to be inserted to the page, and then writes, the result to a free page in another block. Subsequently, the memory controller 112 sets the valid page that was copied to be an invalid page.

The memory 114 is formed by NAND flash memory. In the memory 114, the unit of writing is a page, and the unit of erasure is a block.

The controller 120 receives, from the memory controller 112, information on the logical page address that corresponds to each valid page in the target block that is to be erased at the time of the next garbage collection.

When inserting row data into the memory 114, the controller 120 issues an instruction to insert row data at the logical page address corresponding to a valid page in the target block received from the memory controller 112. Details on the processing when the controller 120 inserts row data are provided below.

When updating row data in the memory 114, the controller 120 issues an instruction to erase the original row data and to insert the new, updated data at the logical page address corresponding to a valid page in the target block received, from the memory controller 112. In other words, the controller 120 executes the process to update row data as a process that combines erasure and insertion. Details on the processing when the controller 120 updates row data are provided below.

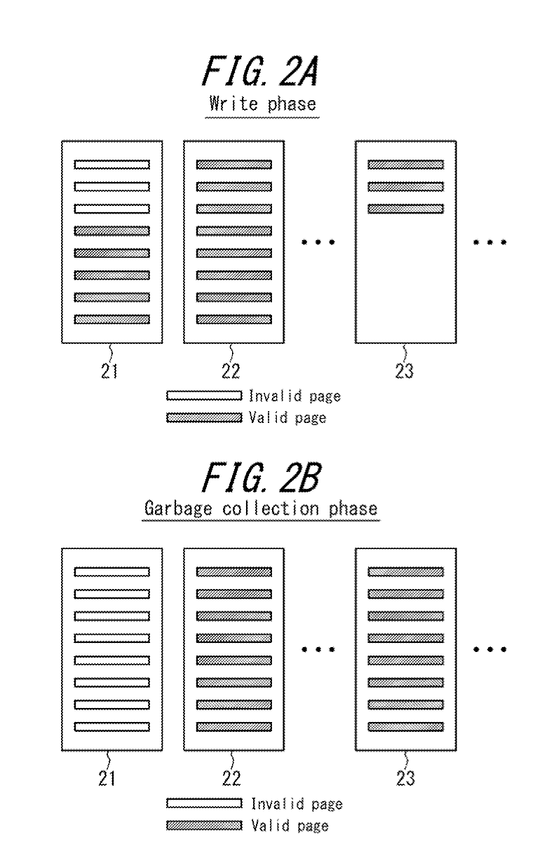

FIGS. 2A and 2B illustrate an example of memory in a data storage system according to one of the disclosed embodiments.

FIG. 2A illustrates an example of the state of block 21, block 22, and block 23 in the memory 114 during the writing phase. In FIG. 2A, block 21 is the target block, and block 23 is a block having free pages.

In the state in FIG. 2A, since the target block is block 21, the memory controller 112 converts the physical page address of a valid page in the target block 21 into a logical page address and provides information on the logical page address to the controller 120. When inserting row data, the controller 120 designates the logical page address of a valid page in the target block 21 as received from the memory controller 112. At this time, since a valid page in the target block 21 cannot be overwritten, the memory controller 112 reads data in the valid page in the target block 21 designated by the controller 120, adds the data to be inserted, and writes the result it a free page in the block 23.

As a result of the process described in FIG. 2A being repeated in the writing phase, all of the pages in the target block 21 are set to invalid pages, as illustrated in FIG. 2B, by the time of the garbage collection phase in which the memory controller 112 begins garbage collection. Accordingly, at the time of garbage collection, valid pages in the target block 21 need not be copied, thereby reducing a degradation in the processing capability at the time of garbage collection.

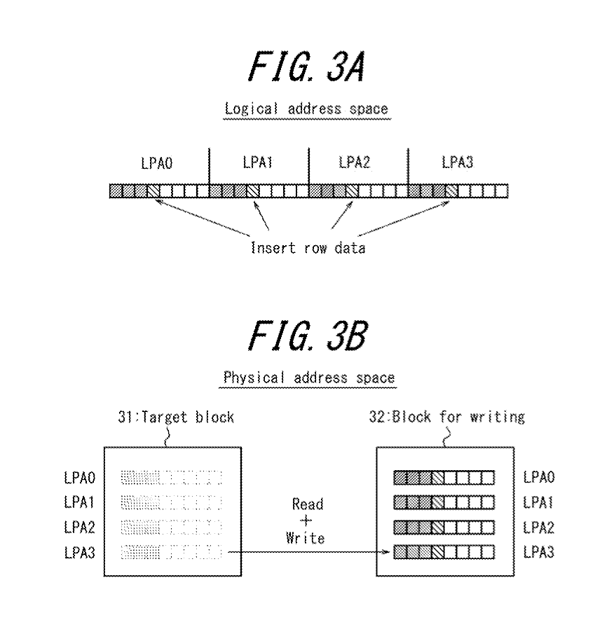

FIGS. 3A and 3B illustrate an example of inserting row data in a data storage system according to one of the disclosed embodiments. FIG. 3A illustrates the logical address space, and FIG. 3B illustrates the physical address space.

In the example illustrated in FIGS. 3A and 3B, the controller 120 receives LPA0 to LPA3 from the memory controller 112 as information on the logical page addresses corresponding to valid pages in the target block 31. For example, when inserting four sets of on data the controller 120 designates logical page addresses LPA0 to LPA3, as illustrated in FIG. 3A, and issues an instruction to insert the row data.

Upon receiving the instruction to insert row data at the logical page addresses LPA0 to LPA3 from the controller 120, then for example as illustrated in FIG. 3B. the memory controller 112 reads the data at the physical page addresses corresponding to the logical page addresses from the target block 31, inserts the row data into the various pages, and writes the result to the block 32 for writing. Subsequently, the memory controller 112 sets the original pages in the target block 31 to be invalid pages.

At this time, the controller 120 does not insert the row data by packing the row data in order from the front, for example so that four sets of row data are all inserted into LPA0, but rather inserts the row data by distributing the row data between LPA0 to LPA3. Since the controller 120 thus inserts the row data by distributing the row data, a state in which each page has free space can be maintained until the space in the memory 114 becomes extremely strained. This allows avoidance of a situation in which, due to a lack of free space in the valid pages in the target block, the controller 120 cannot designate a valid page in the target block as the destination for insertion of row data.

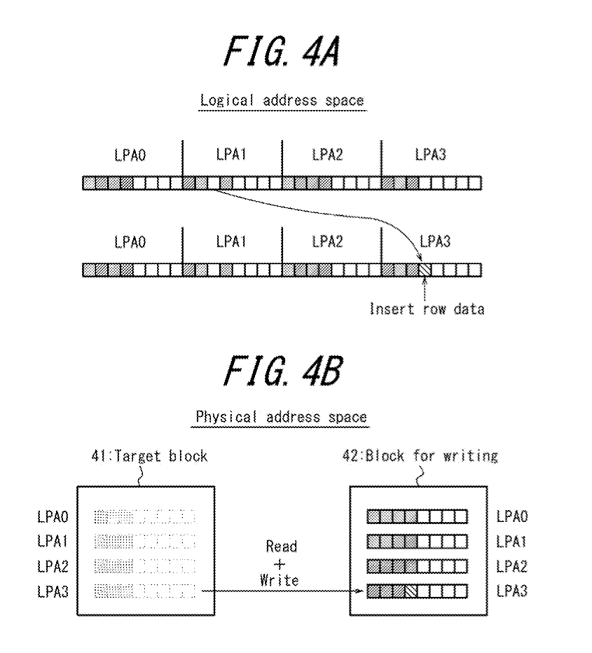

FIGS. 4A and 4B illustrate an example of updating row data in a data storage system according to one of the disclosed embodiments. FIG. 4A illustrates the logical address space, and FIG. 4B illustrates the physical address space.

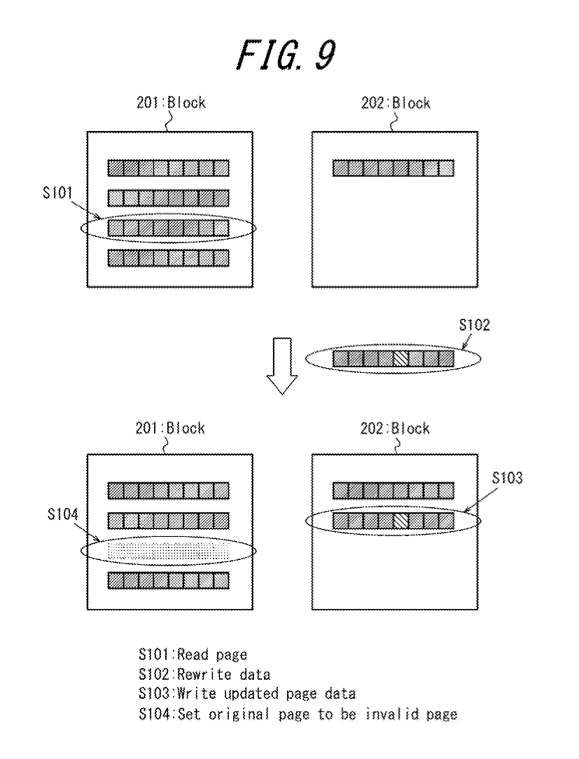

When executing a process to update row data, the controller 120 does not update row data directly as in the process illustrated in FIG. 9, but rather executes the updating process as a process that combines erasure and insertion.

For example, in the example illustrated in FIG. 4A, the controller 120 receives LPA0 to LPA3 from the memory controller 112 as information on the logical page addresses corresponding to valid pages in the target block 41. For example when updating the third row data in LPA1, the controller 120 does not update the third row data in LPA1 with the method illustrated in FIG. 9, but rather issues an instruction to erase the third row data in LPA1, designate the logical page address LPA3, and insert the newly updated row data.

Upon receiving the instruction to insert the newly updated row data at the logical page address LPA3 from the controller 120, then for example as illustrated in FIG. 4B, the memory controller 112 reads the data at the physical page address corresponding to the logical page address LPA3 from the target block 41, inserts the newly updated row data, and writes the result to the block 42 for writing. Subsequently, the memory controller 112 sets the original page in the target block 41 to he an invalid page.

Since the controller 120 thus executes the update process as a process that combines erasure and insertion, a valid page in the target block can be turned into an invalid page in the update process as well, as in the insertion process. As a result, even when the proportion of update processes is high among the processes executed by the data storage system 100, all of the valid pages in the target block can be turned into invalid pages by repeating the update and insertion processes.

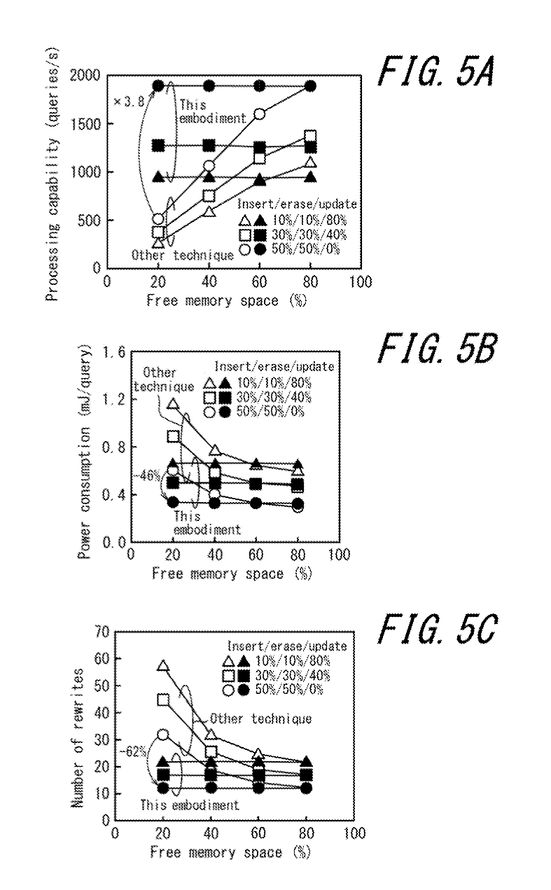

FIGS. 5A, 5B, and 5C illustrate the results of simulating the dependency of characteristics on the free space in the memory in a data storage system according to one of the disclosed embodiments. In FIGS. 5A, 5B, and 5C, the white symbols indicate the simulation results for a conventional technique, and the black symbols indicate the simulation results for this embodiment. The three types of symbols, i.e. triangle, square, and circle, indicate the difference in the ratio of insert/erase/update processes on the data used in the simulation. The respective ratios of insert/erase/update are 10%/10%/80%, 30%/30%/40%, and 50%/50%/0%.

In FIG. 5A, the vertical axis represents processing capability. FIG. 5A shows that with the conventional technique represented by white symbols, the processing capability degrades along with a decrease in free space in the memory 114. By contrast, with this embodiment represented by black symbols, the processing capability exhibits nearly no dependence on the free space in the memory 114. This holds for each of the three ratios of insert/erase/update illustrated in FIG. 5A. For example, a comparison in the case of the insert/erase/update ratio being 50%/50%/0% and the free space in the memory 114 being 20% shows that the processing capability in this embodiment is 3.8 times the processing capability with a conventional technique.

In FIG. 5B, the vertical axis represents power consumption. FIG. 5B shows that with the conventional technique represented by white symbols, the power consumption increases along with a decrease in free spate in the memory 114. By contrast, with this embodiment represented by black symbols, the power consumption exhibits nearly no dependence on the free space in the memory 114. This holds for each of the three ratios of insert/erase/update illustrated in FIG. 5B. For example, a comparison in the case of the insert/erase/update ratio being 50%/50%/0% and the free space in the memory 114 being 20% shows that the power consumption in this embodiment is reduced by 46% as compared to a conventional technique.

In FIG. 5C, the vertical axis represents the number of rewrites when performing predetermined data processing. FIG. 5C shows that with the conventional technique represented by white symbols, the number of rewrites increases along with a decrease in free space in the memory 114. By contrast, with this embodiment represented by black symbols, the number of rewrites exhibits nearly no dependence on the free space in the memory 114. This holds for each of the three ratios of insert/erase/update illustrated in FIG. 5C. For example, a comparison in the case of the insert/erase/update ratio being 50%/50%/0% and the free space in the memory 114 being 20% shows that the number of rewrites in this embodiment is reduced by 62% as compared to a conventional technique.

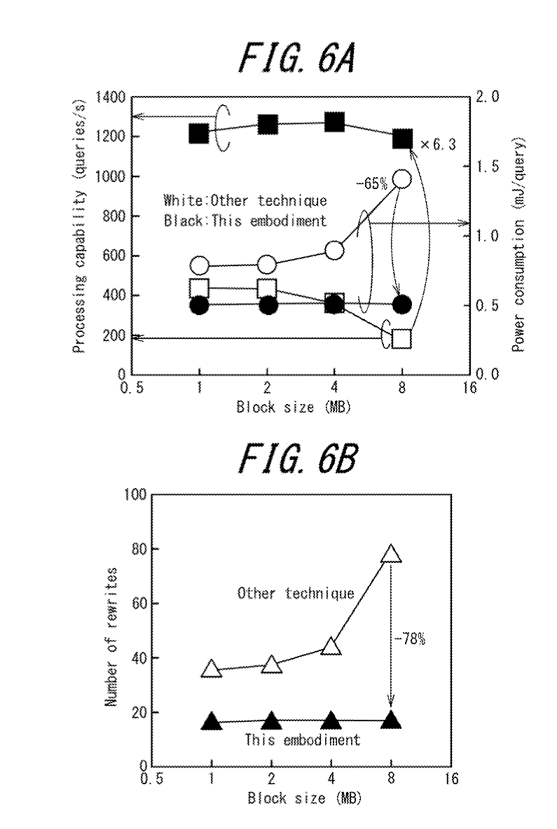

FIGS. 6A and 6B illustrate the results of simulating the dependency of characteristics on the block site in the memory 114 in a data storage system according to one of the disclosed embodiments.

In FIG. 6A, the vertical axis to the left represents processing capability, and the vertical axis to the right represents power consumption. Examination of the characteristics of processing capability in FIG. 6A shows that with the conventional technique represented by white squares, processing capability decreases as the block size increases. By contrast, with this embodiment represented by black squares, there is little dependence on block size. For example, a comparison in the case of the block size being 8 megabytes shows that the processing capability in this embodiment is 6.3 times the processing capability with a conventional technique.

Examination of the characteristics of power consumption in FIG. 6A shows that with the conventional technique represented by white circles, power consumption increases as the block size increases. By contrast, with this embodiment represented by black circles, there is little dependence on block size. For example, as comparison in the case of the block size being 8 megabytes shows that the power consumption in this embodiment is 65% less than with a conventional technique.

The vertical axis in FIG. 6B represents the number of rewrites. Examination of the characteristics of the number of rewrites in FIG. 6B shows that with the conventional technique represented by white triangles, the number of rewrites increases as the block size increases. By contrast, with this embodiment represented by black triangles, there is little dependence on block size. For example, a comparison in the case of the block size being 8 megabytes shows that the power consumption in this embodiment is 78% less than with a conventional technique.

As illustrated in FIGS. 6A and 6B, since the characteristics of the data storage system 100 in this embodiment have little dependency on block size, the characteristics do not degrade even when using a 3D-NAND flash memory with a large block size for the memory 114.

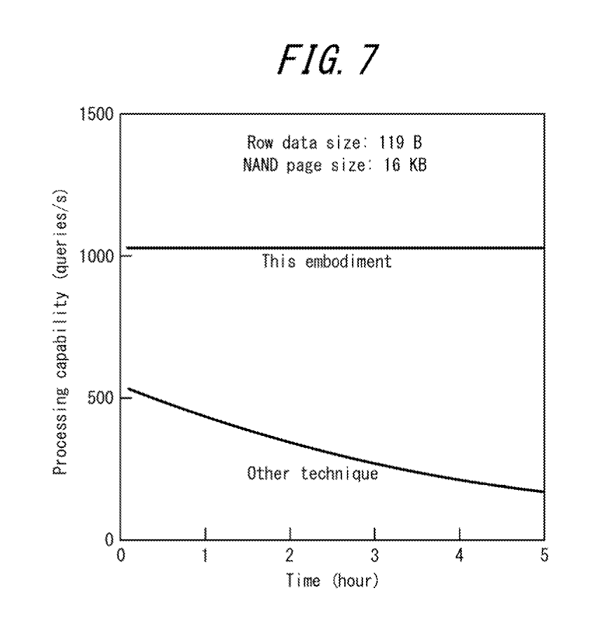

FIG. 7 illustrates the results of simulating the time dependency of processing capability in a data storage system according to one of the disclosed embodiments. FIG. 7 illustrates the results of a simulation in which the size of row data is 119 bytes and the NAND page size is 16 kilobytes.

As illustrated in FIG. 7, the processing capability decreases over time with a conventional technique. The reason is thought to be that as the free memory space decreases over time, the frequency of garbage collection consequently increases, and the copying of valid pages in the target block that occurs at the time of garbage collection is performed frequently. By contrast the data storage system 100 of this embodiment does not copy valid pages in the target block at the time of garbage collection. Hence, even if the free memory space decreases over time, the processing speed remains nearly unchanged.

In this way, by the controller 120 receiving information on the logical page address of a valid page in the target block from the memory controller 112 and issuing an instruction to write data to the logical page address, this embodiment allows the valid pages in the target block to be set to invalid pages. As at result, at the time of garbage collection, since no valid pages remain in the target block, processing to copy the valid pages in the target block becomes unnecessary, thereby achieving an improvement over a conventional technique with respect to all of processing capability, power consumption, and the number of rewrites.

Furthermore, having the controller 120 issue an instruction to distribute and write data to the logical page addresses received from the memory controller 112 reduces the occurrence of a situation in which a valid page cannot be designated for writing due to a lack of free space in the valid pages of the target block.

Since the controller 120 executes the update process as a process that combines erasure and insertion, a valid page in the target block can be turned into an invalid page in the update process as well as in the insertion process.

Having the memory controller 112 start garbage collection once the free space in the memory 114 falls below a predetermined threshold also reduces the chance of the free space in the memory 114 falling below a predetermined value.

Although this disclosure is based on embodiments and drawings, it is to be noted that various changes arid modifications will be apparent to those skilled in the art based on this disclosure. Therefore, such changes and modifications are to be understood as included within the scope of this disclosure.

For example, in the above embodiment, an example of using NAND flash memory as the memory is described, but this disclosure is not limited to NAND flash memory and may be applied to any memory having similar characteristics.

### REFERENCE SIGNS LIST

100 Data storage system
110 Memory unit
112 Memory controller
114 Memory
120 Controller

1. A data storage system comprising:
a memory unit comprising a memory, into which data are written in units of pages, and a memory controller configured to control writing of data to the memory; and
a controller configured to indicate, to the memory controller, a logical page address to which data are to be written, wherein
the memory controller
determines a target block that is a block to be erased when garbage collection is next performed, and
provides the controller with information on a logical page address corresponding to a physical page address of a valid page in the target block, and
the controller instructs the memory controller to write data to the logical page address received from the memory controller.

2. The data storage system of claim 1, wherein the controller instructs the memory controller to write the data by distributing the data between each logical page address received from the memory controller.

3. The data storage system of claim 1, wherein when updating data stored in the memory, the controller instructs the memory controller to erase non-updated data and to write newly updated data to the logical page address received from the memory controller.

4. The data storage system of claim 2, wherein when updating data stored in the memory, the controller instructs the memory controller to erase non-updated data and to write newly updated data to the logical page address received from the memory controller.

5. The data storage system of claim 1, wherein the memory controller starts garbage collection upon free space in the memory falling below a predetermined threshold.

6. A method of controlling a data storage system that includes a memory into which data are written in units of pages, the method comprising:
determining a target block that is a block to be erased when garbage collection is next performed;
converting a physical page address of a valid page in the target block into a corresponding logical page address; and
writing data to the logical page address yielded by conversion.

7. The data storage system of claim 2, wherein the memory controller starts garbage collection upon free space in the memory falling below a predetermined threshold.

8. The data storage system of claim 3, wherein the memory controller starts garbage collection upon free space in the memory falling below a predetermined threshold.

9. The data storage system of claim 4, wherein the memory controller starts garbage collection upon free space in the memory falling below a predetermined threshold.
